(19) United States
(12) Patent Application Publication
(10) Pub. No.: US 2026/0270627 A1
(43) Pub. Date: Sep. 10, 2026

(54) A HEARING AID SYSTEM AND A METHOD OF OPERATING A HEARING AID SYSTEM

(71) Applicant: WIDEX A/S, Lynge (DK)

(72) Inventors: Lars Dalskov MOSGAARD, Copenhagen (DK); Thomas Bo ELMEDYB, Heriev (DK); Ole HAU, Stenloese (DK); David PELEGRIN-GARCIA, Copenhagen (DK); Craig MITCHELL, Hvidovre (DK); Esteban José Fuentes HENRIQUEZ, Copenhagen (DK)

(73) Assignee: WIDEX A/S, Lynge (DK)

(21) Appl. No.: 18/869,430

(22) PCT Filed: Jun. 1, 2023
(86) PCT No.: PCT/EP2023/064718

§ 371 Date: Nov. 26, 2024

(30) Foreign Application Priority Data
Jun. 1, 2022 (DK) PA 2022 00515

(51) Int. Cl. H04R 25/00

(52) U.S. Cl. CPC H04R 25/453; H04R 25/305

(57) ABSTRACT

A hearing aid system with improved adaptive feedback suppression based on an improved feedback path change measure and a method of operating such a hearing aid system.

### 1 FIELD OF THE INVENTION

The present invention relates to hearing aid systems. The invention more particularly relates to hearing aid systems that rely on adaptive feedback cancellation in order to reduce the problems caused by acoustic feedback. The invention also relates to methods of operating hearing aid systems.

### 2 BACKGROUND OF THE INVENTION

### 2.1 What is a Hearing Aid System

Within the context of the present disclosure a hearing aid can be understood as a small, battery-powered, microelectronic device designed to be worn behind or in the human ear by a hearing-impaired user. Prior to use, the hearing aid is adjusted by a hearing aid fitter according to a prescription. The prescription is based on a hearing test, resulting in a so-called audiogram, of the performance of the hearing-impaired user's unaided hearing. The prescription is developed to reach a setting where the hearing aid will alleviate a hearing loss by amplifying sound at frequencies in those parts of the audible frequency range where the user suffers a hearing deficit. A hearing aid comprises one or more microphones, a battery, a microelectronic circuit comprising a signal processor adapted to provide amplification in those parts of the audible frequency range where the user suffers a hearing deficit, and an acoustic output transducer. The signal processor is preferably a digital signal processor. The hearing aid is enclosed in a casing suitable for fitting behind or in a human ear.

Within the present context a hearing aid system may comprise a single hearing aid (a so called monaural hearing aid system) or comprise two hearing aids, one for each ear of the hearing aid user (a so called binaural hearing aid system). Furthermore, the hearing aid system may comprise an external device, such as a smart phone having software applications adapted to interact with other devices of the hearing aid system. Thus within the present context the term “hearing aid system device” may denote a hearing aid or an external device.

Generally a hearing aid system according to the invention is understood as meaning any system which provides an output signal that can be perceived as an acoustic signal by a user or contributes to providing such an output signal and which has means which are used to compensate for an individual hearing loss of the user or contribute to compensating for the hearing loss of the user. These systems may comprise hearing aids which can be worn on the body or on the head, in particular on or in the ear, and can be fully or partially implanted. However, some devices whose main aim is not to compensate for a hearing loss may nevertheless be considered a hearing aid system, for example consumer electronic devices (such as headsets) provided they have some measures for at least partly alleviating an individual hearing loss.

### 2.2 What is Acoustic Feedback

Acoustic feedback from a receiver to one or more microphones will limit the maximum amplification that can be applied in a hearing aid. Due to the feedback, the amplification in the hearing aid can cause resonances, which shape the spectrum of the output of the hearing aid in undesired ways and even worse, it can cause the hearing aid to become unstable, resulting in whistling or howling. The hearing aid usually employs compression to compensate hearing loss; that is, the amplification gain is reduced with increasing sound pressures. Moreover, an automatic gain control is commonly used on the output to limit the output level, thereby avoiding clipping of the signal. In case of instability, these compression effects will eventually make the system marginally stable, thus producing a howl or whistle of nearly constant sound level.

Feedback suppression is often used in hearing aids to compensate the acoustic feedback. The acoustic feedback path can change dramatically over time as a consequence of, for example, amount of earwax, the user wearing a hat or holding a telephone to the ear or the user is chewing or yawning. For this reason, it is customary to apply an adaptation mechanism on the feedback suppression to account for the time-variations.

### 2.2.1 What is Adaptive Feedback Cancellation

One widely used method for feedback suppression in hearing aid systems is based on adaptive feedback cancellation. Reference is therefore first given to FIG. 1 which illustrates highly schematically a hearing aid 100, according to the prior art, comprising means for adaptive feedback cancellation.

The hearing aid 100 comprises at least one acoustical-electrical input transducer 101 providing an input signal 106 (which in the following may also be denoted microphone signal y(n)), a digital signal processor 102 (which in the following may also be denoted hearing aid processor) providing an output signal 111 (which in the following may also be denoted loudspeaker signal u(n)), an electrical-acoustical output transducer 103, an adaptive feedback filter 104 and an adaptive feedback estimator 105.

Acoustic feedback occurs when part of the loudspeaker signal is picked up by a microphone creating an acoustic closed loop. A closed loop system becomes unstable when a magnitude of a signal traveling around the loop does not decrease for each round trip, and the feedback signal adds up in phase with a microphone signal. Hence, feedback limits the maximum stable gain achievable, it deteriorates the sound quality by producing a distortion of an incoming signal and can cause howling when the system becomes unstable.

Feedback problems can be reduced by adaptive feedback cancellation techniques that attempt to model a feedback path response h(n) using the adaptive feedback estimator 105 and the adaptive feedback filter 104 and subtract a modeled feedback signal \hat{v}(n) (which in the following may be denoted feedback cancellation signal 109) provided by the adaptive feedback filter 104 from the microphone signal 106 (y(n)).

In FIG. 1, the adaptive feedback filter 104 provides an estimate ĥ(n) of the true acoustic feedback path response h(n). Ideally, ĥ(n)=h(n) and the feedback cancellation signal 109 (\hat{v}(n)) will hereby be identical to the true feedback signal 108 (v(n)). This implies that a residual signal 110 (e(n)) after subtraction of the feedback cancellation signal 109 (\hat{v}(n)) from the microphone signal 106 (y(n)) will only contain the incoming signal 107 (x(n)) without feedback, i.e. e(n)=x(n).

### 2.2.2 the Biased Estimation Problem

However, a general issue with adaptive feedback cancellation methods for acoustic feedback suppression is that the adaptation generally will not converge towards the optimum suppression of the acoustic feedback due to the biased estimation of ĥ(n).

It can be shown that the bias is given by a cross correlation vector E [u(n)x(n)] between the output signal 111 (u(n)) and the incoming signal 107 (x(n)). Hence, correlation between the output signal 111 and the incoming signal 107 biases the estimation of ĥ(n), and thereby leads to a reduced feedback cancellation performance and may cause the cancellation system to fail and howling to occur.

For most audio signals, the correlation, between the incoming signal 107 and the output signal 111, is strong for short hearing aid signal processing delays and becomes weaker with increasing hearing aid signal processing delays.

### 2.2.3 Frequency Shifting as a Solution to the Biased Estimation Problem

Different techniques have been proposed to reduce the biased estimation problem.

One known technique applies de-correlation (e.g. pre-whitening techniques) in the adaptive estimation path. Generally, the advantage of carrying out the decorrelation in the adaptive estimation path is that this does not modify the receiver signal, such that no sound quality degradation is introduced due to the decorrelation. However, this is often not sufficient to ensure a good and reliable canceler performance. This is especially the case when the incoming signal is tonal and hence highly correlated or when the hearing aid processing delay is low.

Alternatively (or additionally) the canceling performance can be improved by de-correlating the loudspeaker signal 111 relative to the incoming signal 107, e.g. by means of frequency shifting or phase shifting. However, this comes at the price of added delay to the main signal path and audible artifacts caused especially by the interference between directly transmitted sound (i.e. ambient sound transmitted past the hearing aid and towards the ear drum) and the amplified and frequency shifted sound provided by the hearing aid.

### 2.2.4 Applying Probe Noise as a Solution to the Biased Estimation Problem

Another technique for reducing the biased estimation problem is based on adding a probe noise signal to the main signal path.

EP-B1-1742509 describes a hearing aid system comprising a microphone unit adapted to convert said audio input signal to an electric signal, a filter unit adapted to remove a selected frequency band of said electric signal and pass a filtered signal, a synthesizer unit adapted to synthesize said selected frequency band of said electric signal based on said filtered signal thereby generating a synthesized signal, a combiner unit adapted to combine said filtered signal and said synthesized signal thereby generating a combined signal, and an output unit adapted to convert said combined signal to an audio output signal. Thus, this hearing aid system is limited with respect to performance because it requires that an entire frequency band is removed and later replaced by adding a synthesized signal.

### 2.2.5 Problem to be Solved by the Invention

Thus, there is still a need to improve the performance of adaptive feedback cancellation systems especially with respect to obtaining both high performance adaptive feedback cancellation and high sound quality by avoiding audible artefacts.

It is therefore a feature of the present invention to provide a hearing aid system with improved adaptive feedback cancellation while maintaining high sound quality.

It is another feature of the present invention to provide a method of operating a hearing aid system that provides improved feedback cancellation while maintaining high sound quality.

### 3 SUMMARY OF THE INVENTION

The invention is set out in the appended claims.

### 4 BRIEF DESCRIPTION OF THE DRAWINGS

By way of example, there is shown and described a preferred embodiment of this invention. As will be realized, the invention is capable of other different embodiments, and its several details are capable of modification in various, obvious aspects all without departing from the invention. Accordingly, the drawings and descriptions will be regarded as illustrative in nature and not as restrictive. In the drawings:

FIG. 1 illustrates highly schematically a hearing aid with adaptive feedback cancellation according to the prior art;

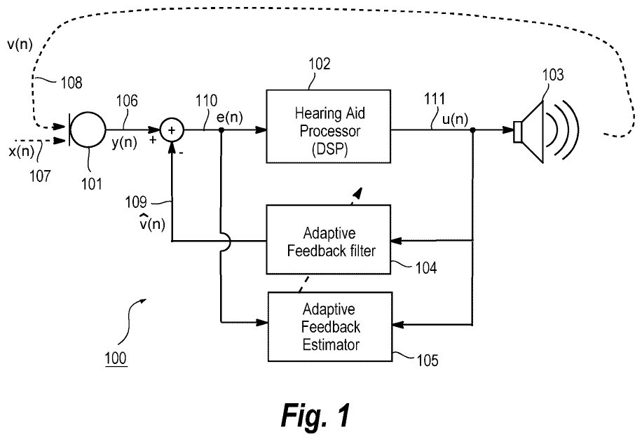

FIG. 2 illustrates highly schematically a hearing aid system according to an embodiment of the invention; and

FIG. 3 illustrates highly schematically a method according to an embodiment of the invention.

### DETAILED DESCRIPTION

In the present context the term “feedback path change measure” may be used interchangeably with the shorter term “change measure” and similarly the terms “time/frequency/phase domain feedback path change measure” may be used interchangeably with the corresponding shorter term “time/frequency/phase domain change measure”. Furthermore, the terms including “change measure” are to be construed to represent a value even though this may not be explicitly stated. Similarly, “feedback change” may be used interchangeably with “feedback path change”, and e.g. the term “signal combiner” may be used interchangeably with “combiner”. Finally, the term “change measure” may be abbreviated CM.

### 4.1 Hearing Aid System Embodiment

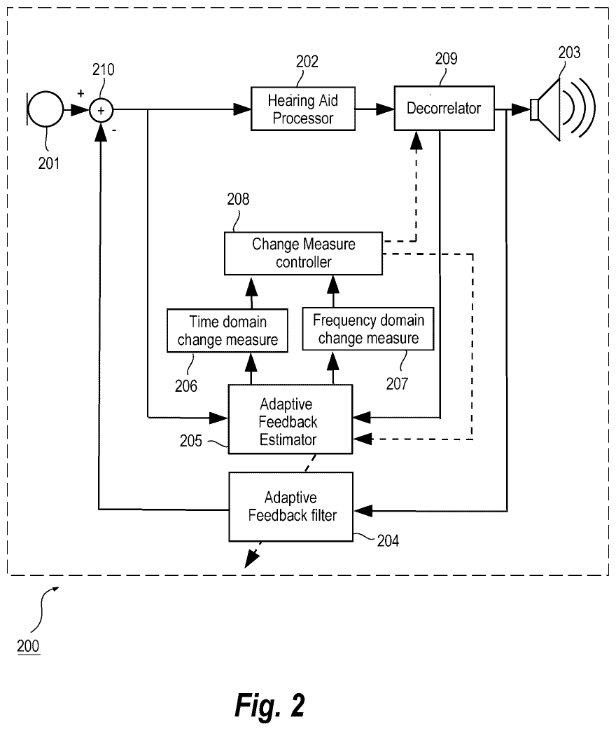

Reference is now made to FIG. 2, which illustrates, highly schematically, a hearing aid system 200 according to an embodiment of the invention. In FIG. 2 the hearing aid system 200 only consists of a single hearing aid, but in a binaural hearing aid system each of the two hearing aids will obviously have the same type of elements in order to provide the functionality of the present invention.

The hearing aid system 200 comprises an acoustical-electrical input transducer 201 that receives an audio input signal and converts this audio input signal into an input transducer output signal. The input transducer output signal is fed into a signal combiner 210. The combiner 210 is configured to subtract a feedback cancellation signal from the input transducer output signal and hereby generate a residual signal. The residual signal is subsequently branched and provided both to an adaptive feedback estimator 205 and to a digital signal processor (DSP) 202 that generates a processed residual signal.

### 4.1.1 De-Correlation Unit 209

The processed residual signal is received by a de-correlation unit 209 that provides a de-correlation to the processed residual signal when active. This can be done in a plurality of ways. According to one embodiment this is carried out by applying a frequency shift to at least a part of the received signal (i.e. the processed residual signal). According to another embodiment the de-correlation can be carried out by adding a probe noise signal to the processed residual signal. The de-correlation unit 209 need not be constantly active and generally it is advantageous only to apply the de-correlation when required in order to avoid feedback issues because the de-correlation unit may provide undesirable sound artifacts when e.g. adding probe noise or frequency shifting the processed residual signal.

According to the present embodiment the de-correlation unit 209 is controlled at least partly by a feedback path change measure controller 208. It is noted that if the de-correlation unit 209 is not active (which in the following may also be denoted deactivated), then it is transparent and the residual processed signal will be equal to an output transducer input signal that is received by an electrical-acoustical output transducer 203 that is configured to generate an acoustical (i.e. audio) output transducer output signal based hereon.

Thus according to an embodiment the de-correlation unit 209 is adapted to frequency shift at least a (frequency) part of the processed residual signals in order to at least decrease a potential correlation between the output transducer input signal and the part of the input transducer output signal that does not comprise a feedback component (the sound which is received by the input transducer 210 and does not comprise a feedback component may in the following be denoted external sound), whereby the adaptive feedback system, comprising the adaptive feedback cancellation filter 204 and the adaptive feedback estimator 205, is given the best conditions for adapting to the current acoustical feedback path by reducing bias. The frequency shifting can be a non-linear transform (however frequency shifting needs not be based on a non-linear transform) which breaks the linearity of the feedback loop. This essentially improves the ability to differentiate between external sounds and a feedback component, which may also be known as reducing the bias.

According to a specific embodiment the frequency shifting is carried out by applying a Hilbert transform as disclosed e.g. in paragraphs [35]-[39] and with reference to FIG. 2 of European patent EP-B1_2671390.

According to an alternative embodiment the de-correlation unit 209 is adapted to add probe noise to the processed residual signal instead of providing a frequency shift. However, the desired effect of the two de-correlation techniques is the same namely reducing the bias and hereby improve the ability of the adaptive feedback system to estimate the feedback path.

According to yet other alternative embodiments the de-correlation unit 209 is adapted such that it can provide at least one of frequency shift, phase shift, probe noise, spectral substitution (wherein at least one complete frequency band (or frequency range) of the amplified signal is replaced with e.g. a known noise signal, as opposed to replacing only a part of said frequency band) and spectral replication wherein some frequency bins of the signal to be de-correlated are replaced with different frequency bands of the same signal.

Thus, according to a more specific embodiment the de-correlation unit is adapted to provide at least two different forms of de-correlation dependent on the circumstances.

This can especially be advantageous when large de-correlation is required.

### 4.1.2 CM Units 206 and 207

The time domain change measure unit 206 and the frequency domain change measure unit 207 are primarily advantageous in that they at least in some circumstances allow a detection of an unstable adaptive feedback cancellation (which will produce an undesirable and quite unpleasant and possibly embarrassing howl from the hearing aid system) before this is audible for user. In traditional adaptive feedback cancellation systems, the methods for detecting a hearing aid howl is based on analysing a signal representing the sound received by the hearing aid system, which makes it very difficult to detect a howl in the early part of the build up process and thus before the howl is audible. By instead analysing the filter characteristics of the adaptive feedback cancellation filter it becomes more likely that a feedback path change is detected before associated sound artefacts become audible.

### 4.1.3 Time Domain CM

According to an embodiment the time domain change measure unit 206 provides a time domain feedback path change measure as a time average of the sign change d(l) for a single filter tap of the adaptive feedback filter using the formula:

$$d ( l ) = \frac{p ( l )}{m} - \frac{n ( l )}{m} \qquad ( eq . 1 )$$

wherein l is the tap index and p,n and m are respectively, the number of calculation steps where the tap value is increasing, the number of calculation steps where the tap value is decreasing and the total number of calculation steps used for determining the time average of the sign change d(l).

According to an alternative embodiment the time domain change measure is provided as a time average of the sign change d(N)_{avg} for a plurality N of filter taps using the formula:

$${d ( N )}_{avg} = \frac{1}{N} {\sum }_{l = 1}^{N} \frac{p ( l )}{m ( l )} - \frac{n ( l )}{m ( l )} = \frac{1}{N} {\sum }_{l = 1}^{N} d ( l ) \qquad ( eq . 2 )$$

wherein N is the number of filter taps (which preferably and according to this specific embodiment comprises all the filter taps of the adaptive feedback filter), l is the tap index and p(l), n(l) and m(l) are respectively, the number of calculation steps where the tap value is increasing, the number of calculation steps where the tap value is decreasing and the total number of calculation steps used for determining the time average of the sign change d(l) for a given single filter tap.

According to another alternative embodiment the time domain change measure is provided as the maximum value of the time average of the sign change d(l) for a plurality of single filter taps. This specific embodiment has turned out to be especially advantageous with respect to detecting a feedback path change early (and hereby enabling a fast response to the change), because of the higher reliability/less noisy detection of feedback path changes.

The above given time domain change measures are especially advantageous because they are based on monitoring the sign change (i.e. monitoring the monotonicity of change) for a (at least one) filter tap as opposed to monitoring the change in the filter tap values as such. This is so because for a converged adaptive filter the changes in the filter tap values for each tap will be around a static mean. However, after a change in the feedback path, the adaptive filter will start adapting towards the new feedback path. During adaptation, the taps will display systematic drift. Depending on the update scheme of the adaptive feedback cancellation filter and the signals in a given situation, the step size for each tap will vary across the convergence process. To avoid that few large steps dominate, it is ideal to monitor the average sign change rather than the mean change in order to improve detection of feedback path changes.

### 4.1.4 Single FD CM

According to an embodiment the frequency domain change measure unit 207 provides a frequency domain feedback path change measure, which may also be denoted frequency domain change measure.

### 4.1.4.1 Real Part

According to a more specific embodiment the frequency domain change measure is determined as the maximum value of a time average of the sign change for the real part of a frequency domain adaptive filter coefficient for a plurality of said real parts of the frequency domain adaptive filter coefficients k. Thus this maximum value may be determined as:

$${CM}_{Max , FD , re} ( {k}_{0} ) = {max}_{k ∈ \{ {k}_{0} - \frac{Δ k}{2} , {k}_{0} + \frac{Δ k}{2} \}} \{ abs ( {d}_{re} ( k ) ) \} \qquad ( eq . 3 )$$

wherefrom it follows that CM_{Max,FD,re}(k₀) for the frequency k₀ is determined as the maximum value of dᵣₑ(k) for a sliding frequency window of width Δk around k₀, and wherein dᵣₑ(k), in analogy with the time domain change measure d(l) given above, is given as:

$${d}_{re} ( k ) = \frac{{p}_{re} ( k )}{{m}_{re}} - \frac{{n}_{re} ( k )}{{m}_{re}} \qquad ( eq . 4 )$$

wherein k is the frequency domain filter coefficient index and pᵣₑ, nᵣₑ and mᵣₑ are respectively, the number of calculation steps where the value of the real part of the frequency domain filter coefficient is increasing, the number of calculation steps where said value is decreasing and the total number of calculation steps used for determining the time average of the sign change dᵣₑ (k).

### 4.1.4.2 Imaginary Part

According to a more specific embodiment the frequency domain change measure is determined as the maximum value of a time average of the sign change for the imaginary part of a frequency domain adaptive filter coefficient for a plurality of said imaginary parts of the frequency domain adaptive filter coefficients k. Thus this maximum value may be determined as:

$${CM}_{Max , FD , im} ( {k}_{0} ) = {max}_{k ∈ \{ {k}_{0} - \frac{Δ k}{2} , {k}_{0} + \frac{Δ k}{2} \}} abs ( {d}_{im} ( k ) ) \qquad ( eq . 5 )$$

wherefrom it follows that CM_{Max,FD,im}(k₀) for the frequency k₀ is determined as the maximum value of dᵢₘ(k) for a sliding frequency window of width Δk around k₀, and wherein dᵢₘ(k), in analogy with the time domain change measure d(l) given above, is given as:

$${d}_{im} ( k ) = \frac{{p}_{im} ( k )}{{m}_{im}} - \frac{{n}_{im} ( k )}{{m}_{im}} \qquad ( eq . 6 )$$

wherein k is the frequency domain filter coefficient index and pᵢₘ, nᵢₘ and mᵢₘ are respectively, the number of calculation steps where the value of the imaginary part of the frequency domain filter coefficient is increasing, the number of calculation steps where said value is decreasing and the total number of calculation steps used for determining the time average of the sign change dᵢₘ(k).

### 4.1.4.3 Double FD CM

According to another specific embodiment the frequency domain change measure is determined as the maximum value of a time average of the sign change for both the real part and the imaginary part of a frequency domain adaptive filter coefficient for a plurality of said real and imaginary parts of the frequency domain adaptive filter coefficients k. Thus, this maximum value may be determined as:

$${CM}_{Max , FD} ( {k}_{0} ) = {max}_{k ∈ \{ {k}_{0} - \frac{Δ k}{2} , {k}_{0} + \frac{Δ k}{2} \}} \{ abs ( {d}_{re} ( k ) ) , abs ( {d}_{im} ( k ) ) \} \qquad ( eq . 7 )$$

wherein k, dᵣₑ(k) and dᵢₘ(k) are already given above.

Compared to the time domain change measure, the frequency domain change measures are advantageous in that they provide a frequency dependent change measure which e.g. enables de-correlation to be applied only in a limited frequency range, if the feedback path change is limited to this frequency range, whereby undesirable sound artefacts may be avoided.

As will be well known for the skilled person the frequency domain adaptive filter coefficients are determined by a discrete Fourier transforming the time domain adaptive filter coefficients. Thus, the frequency domain adaptive filter coefficients represent the frequency response of the adaptive filter.

### 4.1.5 Phase Doman CM

According to an embodiment a phase domain change measure may be determined as a time average of the sign change of the phase of the frequency response of the adaptive feedback cancellation filter for a given frequency. Thus, the phase domain change measure is a special type of frequency domain change measure.

Like for the time domain filter taps, if an adaptive filter has converged, the change in phase of the frequency response at any given frequency is symmetric around a static mean phase. However, if the adaptive filter is not in a converged state, the frequency response of the filter will show a systematic drift of the mean phase, particularly in cases where there are drifts in the impulse response. Subtle drift, or sideways shift, in the impulse response can be observed in the feedback path when a reflector is moving (e.g. a hand moving around the ear), a common and difficult scenario to detect for standard adaptive feedback cancellation systems. Another difficult scenario results when a minor re-positioning of an ear piece, say in the range of 5 mm is made. For these and similar scenarios use of a phase domain change measure is preferred.

Therefore, consider now an update step of an adaptive filter that may be given as δHₖ(f)=|δHₖ(f)|e^{-iθ}^{ₖ}^{(f)}, wherein Hₖ(f) is the frequency response of the adaptive feedback cancellation filter, where θₖ is the phase change of the frequency response of the adaptive feedback cancellation filter for the update step k and where the update step is considered to be small such that we can assume

$${θ}_{k} ( f ) ∈ [ - \frac{π}{2} ; + \frac{π}{2} ] ∀ f \& k .$$

To remove the bias effects of the amplitude change and only observe systematic changes in the phase, independently of the step size, we can monitor if the phase changes positively or negatively by observing if the imaginary part of δHₖ(f) is positive or negative respectively.

More specifically, this is done by first determining the unbiased mean phase \hat{θ} of the frequency response of the adaptive feedback cancellation filter as:

$$R {e}^{- i \hat{θ}} = ( 1 - v ) {e}^{- i \hat{θ}} = \frac{1}{M} {\sum }_{k = 1}^{M} {e}^{- i {θ}_{k}} \qquad ( eq . 8 )$$

wherein R is the resultant length, v is the circular variance, and M is the number of calculation steps. Based hereon a time average of a sign change ρ(f) of the phase of the frequency response of the adaptive feedback cancellation filter can be determined based on the expression:

$$R ( f ) {e}^{- i \hat{θ} ( f )} = iR ( f ) ρ ( f ) = - \frac{P ( f )}{M} i + \frac{N ( f )}{M} i \qquad ( eq . 9 )$$

wherein P(f) is the number of calculation steps where the change of the phase of the frequency response is positive, N(f) is the number of calculation steps where the change of the phase of the frequency response is negative and M is the total number of calculation steps used in the average. In the following ρ(f) may also be denoted the phase domain change measure. The phase domain change measure is especially advantageous for detecting slight shifts in the feedback path, whereas the time domain change measure is optimum for detecting more fundamental changes in the feedback path. As a consequence the combination of time domain and phase domain change measures offer a combined feedback path change measure that is better suited for detecting different types feedback path changes.

Investigating the behavior of R(f)ρ(f) it becomes apparent that during changes in the feedback path, patterns across frequencies appear, particularly a local wave around zero is observed to reliably predict a change.

### 4.1.6 CM Controller 208

According to an embodiment the feedback path change measure controller 208, is configured to control the adaptation speed of the adaptive feedback filter 204 (by providing input to the adaptive feedback estimator 205) in addition to controlling the de-correlation unit 209 as described above, whereby tracking of the feedback path is enhanced and consequently the risk of feedback howling is minimized. However, in principle the feedback path change measure controller 208 can be configured to control only one of the two. More specifically, the amount of applied de-correlation is controlled based on the change measures, thus if a frequency dependent change measure is monitored the applied de-correlation can be limited to the frequency range where the change measure has detected a feedback path change. Furthermore, the applied de-correlation enables the adaptation speed of the adaptive feedback system to be increased, whereby the adaptive feedback filter can converge faster and consequently undesirable sound artefacts, such as howls, can be avoided.

It has been found that by using the change measures according to the present invention significant changes to the feedback path can be identified within 50 milliseconds (without too many false positives) which generally is sufficient to avoid sound artefacts.

Anyway, the feedback path change measure controller 208 operates at least partly based on receiving input comprising at least one of a time domain change measure from the time domain change measure unit 206 and a frequency domain change measure from the frequency domain change measure unit 207. However, as will be obvious for the skilled person the feedback path change measure controller 208 may also be configured to additionally receive input directly from e.g. the adaptive feedback estimator 205. According to one embodiment a measure of the uncertainty in the feedback estimate is used to increase the change measure averaging length as a function of an increasing uncertainty measure.

As will likewise be obvious for the skilled person the time domain change measure unit 206 and the frequency domain change measure unit 207 need not be separate units, but may e.g. instead be integrated in the adaptive feedback estimator 205. Similarly, the feedback path change measure controller 208 may also be integrated in the adaptive feedback estimator 205.

### 4.1.7 Combined CMs

### 4.1.7.1 TD & FD CM's

According to an embodiment, the feedback path change measure controller 208 receives input comprising both a time domain change measure from the time domain change measure unit 206 and a frequency domain change measure from the frequency domain change measure unit 207 and based hereon provides a combined time domain and frequency domain change measure.

One specific advantage of such a combined change measure is that the frequency domain change measure can be determined as a function of frequency (see e.g. equation 7) and consequently the combined change measure can be used to control the amount of de-correlation and/or adaptation speed of the feedback cancellation system to apply as a function of frequency, while on the other hand maintaining the higher reliability (e.g. by detecting feedback path changes with few false positives) provided by the less noisy time domain change measure.

Another advantage of such a combined feature is that it can alleviate the amount of processing resources, e.g. by enabling a reduction of the number of samples (m, or mᵢₘ) for the time averaging used to determine the frequency domain time measure, without significantly reducing the achieved performance.

According to alternative embodiments frequency domain change measures given by equation 3 or by equation 5 may be used to provide the frequency dependent change measure instead of equation 7, and it is noted that the choice of the specific frequency domain change measure is independent on the other parts of the feedback cancellation system according to the present invention.

### 4.1.7.2 TD & PD CM

Thus time domain and phase domain change measures offer different ways of detecting a change in the feedback path. While the first measure is tailored for detecting fundamental changes in the feedback path, slight shifts in the feedback path are still difficult to detect. For this, the phase domain change measure can be used. Due to the different nature of the two measures, they can beneficially be combined into a single and more reliable measure. A simple method is to average the two measures. However, other more elaborate schemes can also be used, e.g. converting both change measures to a probability and treating these two measures as independent sources. In combining the measures one can not only minimize estimation noise, but also balance the detection to be sensitive to both fundamental changes in the feedback path and to slight shifts, both of which are behaviors known to happen in the use of hearing aids.

### 4.1.8 Estimation Noise

However, generally feedback path change measures suffer from estimation noise due to the relatively short time averaging windows that are required in order to provide fast detection of feedback path changes, such that counter measures can be activated in order to avoid sound artifacts.

In order to alleviate the estimation noise, and according to one specific embodiment the time domain change measure CM_{TD} and the frequency domain change measure CM_{FD} can be combined into a smoothed change measure C̅M̅(̅n̅)̅. According to one embodiment this can be carried out e.g. using the formula below for determining the smoothed change measure:

$$\overline{CM} ( n ) = a \cdot \overline{CM} ( n - 1 ) + ( 1 - a ) CM ( n ) \qquad ( eq . 10 )$$

wherein n represents a time step, and “a” is a smoothing factor with a value between zero and one. According to a more specific embodiment the smoothing factor “a” has a value in the range between 0.95 and 0.99 for an update rate of 1 kHz.

According to an embodiment time—and frequency domain change measures can be combined by multiplying them together. The two change measures to be combined may be smoothed or not. In the former case we get a combined change measure C̅o̅m̅b̅C̅M̅(n):

$$\overline{CombCM} ( n ) = \overline{{CM}_{TD}} ( n ) \cdot \overline{{CM}_{FD}} ( n ) \qquad ( eq . 11 )$$

This combined change measure provides a significantly reduced estimation noise and hereby also a significantly reduced noise floor, during periods without feedback path changes. But on the other hand change measure sensitivity generally suffers if only one out of the two change measures detect feedback path changes.

Therefore, according to another embodiment the combined change measure C̅o̅m̅b̅C̅M̅(n) is determined as a weighted linear combination of the smoothed change measures (however, alternatively non-smoothed change measures could have been used):

$$\overline{CombCM} ( n ) = b \cdot \overline{{CM}_{TD}} ( n ) + ( 1 - b ) \cdot \overline{{CM}_{FD}} ( n ) \qquad ( eq . 12 )$$

This combined change measure provide a reduction of the estimation noise (and hereby the noise floor) that is not as good as the previous combined change measure, but on the other sides provides an improved sensitivity to feedback path changes and this is independent on whether both or only one out of the two change measures detect feedback changes. According to one embodiment the value of b is 0.5, or in the range between 0.3 and 0.7.

According to another embodiment the change measures are combined by converting both to a probability and treating these two probabilities as independent.

Having realized the benefits that can be achieved by combining e.g. a time domain change measure with a frequency domain change measure as explained above, it follows directly that similar benefits can be achieved by combining a phase domain change measure with either a time domain or a frequency domain change measure or by combining all three types of change measures.

### 4.1.9 AFC Systems

According to an embodiment determination of at least one change measure, according to the invention, may advantageously be used to control an adaptive feedback cancellation (AFC) system that is robust (i.e. has a low bias due to some form of de-correlation being applied). Examples of such robust AFC systems are already given above but comprise systems that use at least one of probe noise, decorrelation of the output signal in the form of frequency shifting or phase shifting, spectral substitution and spectral replication. The change measures according to the present invention may also advantageously be used by AFC systems based on the prediction error method (PEM) that may apply at least one of de-correlation and control of the adaptation speed of the adaptive feedback cancellation filter.

### 4.2 Method Embodiment

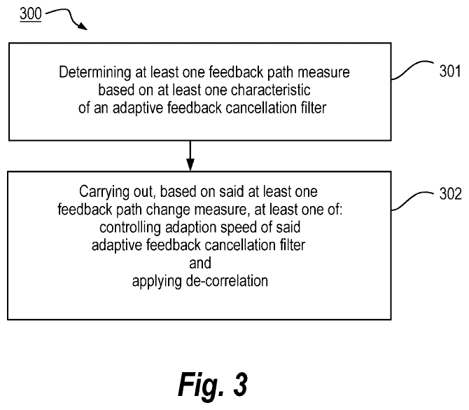

Reference is now made to FIG. 3, which illustrates highly schematically a flow diagram of a method 300 of operating a hearing aid system with adaptive feedback cancellation. The following steps of the inventive method can be carried out by the hearing aid system.

In a first step 301 of the method at least one feedback path change measure is determined based on at least one characteristic of an adaptive feedback cancellation filter.

In step 302, at least one of controlling adaptation speed of said adaptive feedback cancellation filter and applying decorrelation is carried out based on said at least one feedback path change measure.

### 4.3 Variations

It is generally noted that even though many features of the present invention are disclosed in embodiments comprising other features then this does not imply that these features by necessity need to be combined exactly as disclosed above.

On the most general level it is noted that the different change measures according to the invention are independent on the specific action taken by the adaptive feedback system based on the change measures. However, the change measures according to the present invention are especially advantageous for actions that benefit from a fast detection of a change in the feedback path.

On the most general level, it is emphasized that the concept of monitoring an adaptive feedback cancellation filter and based hereon provide (at least one) change measure adapted to make a fast detection of a feedback path change is independent of the type(s) of change measure used. In other words the change measure may be based in the time domain or in the frequency domain, wherein the latter comprises the phase domain or be based on a plurality of these.

Thus a plurality of change measures can generally be combined in a number of different ways in order to provide a (combined) change measure with improved characteristics. However, this is not required, since the advantage of the invention can also be obtained using only a single change measure.

One such combination consists of a time domain CM and a frequency domain CM. By combining these two types of change measures a frequency dependent combined CM having the high quality detection properties of the time domain CM, which it not achievable based on a time domain CM alone because this is independent of frequency. It is noted that this advantageous effect is generally independent of the method used to combine the time domain and frequency domain CMs, i.e. whether they are combined based on e.g. an averaging, a linear weighting or by a multiplication.

Another such combination consists of a time domain CM and a phase domain CM which is especially advantageous because the phase domain CM is very good at detecting slight shifts in the feedback path, whereas the time domain CM generally is optimum for detecting more fundamental changes in the feedback path.

1. A method of operating a hearing aid system with adaptive feedback cancellation comprising the steps of:
a) determining at least one feedback path change measure based on at least one characteristic of an adaptive feedback cancellation filter;
b) carrying out, based on said at least one feedback path change measure, at least one of: controlling adaptation speed of said adaptive feedback cancellation filter and applying decorrelation.

2. The method according to claim 1, wherein step a) comprises the further steps of:
a-1) determining a first feedback path change measure based on a time domain characteristic of said adaptive feedback cancellation filter,
a-2) determining a second feedback path change measure based on a frequency domain characteristic of said adaptive feedback cancellation filter, and
a-3) combining said first and second feedback path change measures and hereby providing an improved feedback path change measure based on at least two characteristics of the adaptive feedback cancellation filter.

3. The method according to claim 2 comprising the further steps of:
using the feedback path change measure based on a frequency domain characteristic of said adaptive feedback cancellation filter to determine a frequency range wherein to apply de-correlation.

4. The method according to claim 1, wherein the decorrelation is applied using at least one of: adding a probe noise signal, providing spectral substitution, providing spectral replication, and providing de-correlation of an output signal in the form of a frequency shift or a phase shift of said output signal.

5. The method according to claim 1, wherein step a) comprises the step of determining a first feedback path change measure based on a time domain characteristic of said adaptive feedback cancellation filter by carrying out at least one of:
determining the first feedback path change measure as a time average of the sign change d(1) for a single filter tap using the formula:
$$d ( l ) = \frac{p ( l )}{m} - \frac{n ( l )}{m}$$
wherein l is the tap index and p,n and m are respectively, the number of calculation steps where the tap value is increasing, the number of calculation steps where the tap value is decreasing and the total number of calculation steps used for determining the time average of the sign change d(l); and
determining the first feedback path change measure as a time average of the sign change d(N)_{avg} for a plurality N of filter taps using the formula:
$${d ( N )}_{avg} = \frac{1}{N} {\sum }_{l = 1}^{N} \frac{p ( l )}{m ( l )} - \frac{n ( l )}{m ( l )} = \frac{1}{N} {\sum }_{l = 1}^{N} d ( l )$$
wherein N is the number of filter taps, l is the tap index and p(l), n(l) and m(l) are respectively, the number of calculation steps where the tap value is increasing, the number of calculation steps where the tap value is decreasing and the total number of calculation steps used for determining the time average of the sign change d(l) for a given single filter tap; and
determining the first feedback path change measure as the maximum value of the time average of the sign change d(l) for a plurality of single filter taps.

6. The method according to claim 1, wherein step a) comprises the step of determining a first feedback path change measure based on a frequency domain characteristic of said adaptive feedback cancellation filter by carrying out the steps of:
determining a maximum value of a time average of the sign change for the real part of a frequency domain adaptive filter coefficient for a plurality of said real parts of the frequency domain adaptive filter coefficients k using the formula:
$${CM}_{Max , FD , r e} ( {k}_{0} ) = {max}_{k ∈ \{ {k}_{0} - \frac{Δ k}{2} , {k}_{0} + \frac{Δ k}{2} \}} \{ abs ( {d}_{re} ( k ) ) \}$$
wherefrom it follows that CM_{Max,FD,re}(k₀) for the frequency k₀ is determined as the maximum value of dᵣₑ(k) for a sliding frequency window of width Δk around k₀, and wherein dᵣₑ (k) is given as:
$${d}_{re} ( k ) = \frac{{p}_{re} ( k )}{{m}_{re}} - \frac{{n}_{re} ( k )}{{m}_{re}}$$
wherein k is the frequency domain filter coefficient index and pᵣₑ, nᵣₑ and mᵣₑ are respectively, the number of calculation steps where the value of the real part of the frequency domain filter coefficient is increasing, the number of calculation steps where said value is decreasing and the total number of calculation steps used for determining the time average of the sign change dᵣₑ(k); or
determining a maximum value of a time average of the sign change for the imaginary part of a frequency domain adaptive filter coefficient using the formula:
$${CM}_{Max , FD , im} ( {k}_{0} ) = {max}_{k ∈ \{ {k}_{0} - \frac{Δ k}{2} , {k}_{0} + \frac{Δ k}{2} \}} abs ( {d}_{im} ( k ) )$$
wherefrom it follows that CM_{Max,FD,im}(k₀) for the frequency k₀ is determined as the maximum value of dᵢₘ(k) for a sliding frequency window of width Δk around k₀, and wherein dᵢₘ(k), is given as:
$${d}_{im} ( k ) = \frac{{p}_{im} ( k )}{{m}_{im}} - \frac{{n}_{im} ( k )}{{m}_{im}}$$
wherein k is the frequency domain filter coefficient index and pᵢₘ, nᵢₘ and mᵢₘ are respectively, the number of calculation steps where the value of the imaginary part of the frequency domain filter coefficient is increasing, the number of calculation steps where said value is decreasing and the total number of calculation steps used for determining the time average of the sign change dᵢₘ(k); or
determining the frequency domain change measure as the maximum value of a time average of the sign change for both the real part and the imaginary part of a frequency domain adaptive filter coefficient for a plurality of said real and imaginary parts of the frequency domain adaptive filter coefficients k using the formula:
$${CM}_{Max , FD} ( {k}_{0} ) = {max}_{k ∈ \{ {k}_{0} - \frac{Δ k}{2} , {k}_{0} + \frac{Δ k}{2} \}} \{ abs ( {d}_{re} ( k ) ) , abs ( {d}_{im} ( k ) ) \}$$

7. The method according to claim 2 wherein said step of combining said first and second feedback path change measures comprises the further step of:
using the formula:
$$CombCM ( n ) = {CM}_{TD} ( n ) \cdot {CM}_{FD} ( n )$$
wherein CombCM(n) represents the combination of a time domain change measure CM_{TD}(n) and a frequency domain change measure CM_{FD}(n); or
using the formula:
$$CombCM ( n ) = b \cdot {CM}_{TD} ( n ) + ( 1 - b ) \cdot {CM}_{FD} ( n )$$
wherein b is a weighting parameter for the linear combination of the time domain change measure CM_{TD}(n) and the frequency domain change measure CM_{FD}(n);

8. A computer-readable medium comprising instructions which, when executed by a computer, cause the computer to carry out the method of claim 1.

9. A hearing aid system comprising a feedback path change measure unit and a change measure controller, wherein said feedback path change measure unit is adapted to determine a feedback path change measure based on at least one characteristic of an adaptive feedback cancellation filter and wherein said change measure controller is adapted to at least one of controlling adaptation speed of an adaptive feedback cancellation filter and applying decorrelation.

10. The hearing aid system according to claim 9, wherein said feedback path change measure is further adapted to:
determine a first feedback path change measure based on a time domain characteristic of said adaptive feedback cancellation filter,
determine a second feedback path change measure based on a frequency domain characteristic of said adaptive feedback cancellation filter, and
combine said first feedback path change measure and said second feedback path change measure and hereby provide an improved feedback path change measure based on at least two characteristics of the adaptive feedback cancellation filter.
